(19) United States
(12) Patent Application Publication
(10) Pub. No.: US 2020/0293528 A1
(43) Pub. Date: Sep. 17, 2020

(54) SYSTEMS AND METHODS FOR AUTOMATICALLY GENERATING STRUCTURED OUTPUT DOCUMENTS BASED ON STRUCTURAL RULES

(71) Applicant: Examination Management Services, Inc., Irving, TX (US)

(72) Inventors: John Jonassen, Binghamton, NY (US); Chinita Scales, Harker Heights, TX (US); Rebecca Rameriz, Robinson, TX (US); Coleen Moser, Omaha, NE (US)

(21) Appl. No.: 16/299,071

(22) Filed: Mar. 11, 2019

(51) Int. Cl. G06F 16/2452; G06F 17/27; G06F 16/35; G06F 17/24; G06F 17/28

(52) U.S. Cl. CPC G06F 16/24522; G06F 17/278; G06F 17/2881; G06F 17/241; G06F 16/355

(57) ABSTRACT

Methods and systems for ingesting unstructured data and generating, based on structural rules, structured output reports that are easily digestible are provided. In embodiments, unstructured data is received from at least one source. At least a portion of the unstructured data is classified into an appropriate category. A citation is selected to be included in the at least one structured report, and at least one structural rule is applied to the selected citation to determine at least one field associated with the selected citation. The structural rule defines the at least one field. Information relevant to the at least one field is identified based on the classified unstructured data, and the at least one field is populated with the information identified as relevant. The at least one structured report is generated based at least in part on the populated information.

### TECHNICAL FIELD

The present subject matter is directed generally to structured output generation, and more particularly to creating structured documents or reports based on structural rules.

### BACKGROUND

Many fields require a voluminous amount of data to be generated and there are many reasons to subsequently review this data. One example industry for which this is particularly true is the insurance field. While making decisions on insurability, analysts must spend countless hours sorting through thousands of documents (e.g., medical records, financial data, etc.) in order to identify relevant information that may help them to make decisions. In some cases, reviewers may generate summaries of the different documents that are reviewed, but even these summaries contain large amounts of information, making their benefits marginal. Making the review and summarizing process more complicated is the fact that the data reviewed is typically unstructured data, in the sense that the data includes natural language expressions rather than structured language fields. This is particularly problematic for automation, as it is more difficult to automate searching and extraction of information from unstructured data. Analysts thus must parse through the large amounts of data looking for relevant information, which may lead to missed information, and is at least a very expensive exercise.

Some solutions have been proposed to address the above challenges. In one particular solution, the source documents are merely digitized (e.g., with an optical character recognition program), which allows an analyst to perform digital searches, but in reality this digitization does not have a meaningful impact on the amount of data that must be reviewed. In addition, source documents may have different formats, which may require different software to be used to process and search the differently formatted documents.

In another solution, source data may be abstracted and condensed. For example, certain data may be filtered out. However, in these solutions, although the source data is reduced, this solution does not provide and structuring functionality, which leaves the issues with automation, and may still remain error prone because of the utilization of simplistic filtering.

### SUMMARY

The present application relates to systems and methods for ingesting unstructured data and generating, based on structural rules, structured output reports/documents that are easily digestible. In one particular embodiment, a method of automatically generating a structured report based on at least one structural rule may be provided. The method may include receiving unstructured data from at least one source, and classifying at least a portion of the unstructured data into an appropriate category. The method may also include selecting a citation to be included in the structured report, and applying at least one structural rule to the selected citation to determine at least one field associated with the selected citation. The at least one structural rule may define the at least one field associated with the selected citation. The method further includes identifying, based on the classified at least a portion of the unstructured data, information relevant to the at least one field associated with the selected citation, and populating the at least one field associated with the selected citation with the information identified as relevant. The method also includes generating the structured report based at least in part on the populated information.

In another embodiment, a system for automatically generating a structured report based on at least one structural rule may be provided. The system may include an input/output device configured to receive unstructured data from at least one unstructured data source, and a server. The server may be configured to receive unstructured data from at least one source, and to classify at least a portion of the unstructured data into an appropriate category. The server may also be configured to select a citation to be included in the at least one structured report, and apply at least one structural rule to the selected citation to determine at least one field associated with the selected citation. The at least one structural rule may define the at least one field associated with the selected citation. The server may further be configured to identify, based on the classified at least a portion of the unstructured data, information relevant to the at least one field associated with the selected citation, and to populate the at least one field associated with the selected citation with the information identified as relevant. The server may also be configured to generate the at least one structured report based at least in part on the populated information.

In yet other embodiments, a computer-based tool for automatically generating at least one structured report based on at least one structural rule may be provided. The computer-based tool may include non-transitory computer readable media having stored thereon computer code which, when executed by a processor, causes a computing device to perform operations. The operations may include receiving unstructured data from at least one source, and classifying at least a portion of the unstructured data into an appropriate category. The operations may also include selecting a citation to be included in the at least one structured report, and applying at least one structural rule to the selected citation to determine at least one field associated with the selected citation. The at least one structural rule may define the at least one field associated with the selected citation. The operations further include identifying, based on the classified at least a portion of the unstructured data, information relevant to the at least one field associated with the selected citation, and populating the at least one field associated with the selected citation with the information identified as relevant. The operations also include generating the at least one structured report based at least in part on the populated information.

The foregoing broadly outlines the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a system configured to perform operations in accordance with embodiments of the present disclosure;

FIG. 2 shows a server configured to perform operations in accordance with embodiments of the present disclosure;

FIG. 3 shows a functional flow diagram illustrating an example flow executed to implement aspects of the present disclosure;

FIG. 4A shows an example of a portion of a human-readable structured report in accordance with embodiments of the present disclosure;

FIG. 4B shows another portion of the human-readable structured report in accordance with embodiments of the present disclosure;

FIG. 4C shows a portion of a machine-readable structured report in accordance with embodiments of the present disclosure; and

FIGS. 5-17 show various views of a graphical user interface view configured in accordance with embodiments of the present disclosure.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

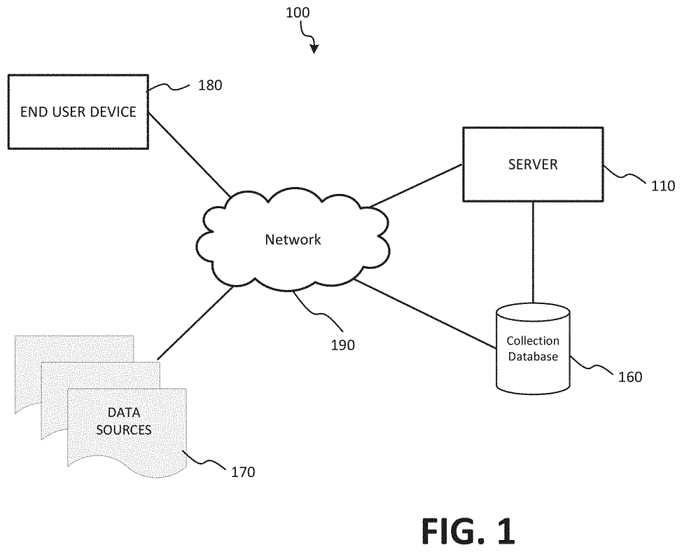

FIG. 1 is a block diagram of an exemplary system 100 configured with capabilities and functionality described below, including, for ingesting unstructured data, classifying and tagging the unstructured data, identifying relevant data to populate fields of structured reports, and generating, based on structural rules and the relevant data, the structured output reports that are easily digestible in accordance with embodiments of the present application. As shown in FIG. 1, system 100 includes server 110, collection database 160, data sources 170, end user device 180, and network 190. These components, and their individual components, discussed in more detailed below, may cooperatively operate to provide functionality in accordance with the discussion herein. For example, in operation according to some embodiments, data from data sources 170 may be provided, via network 190, to collection database 160 and may be compiled into a collection of data in collection database 160. The data may then be provided as input to server 110. In some embodiments, the data from data sources 170 may additionally, and/or alternatively, be provided directly to server 110. The various components of server 110 may cooperatively operate to analyze, classify, and tag at least a portion of the data, and to apply selectable structural rules to the data to generate structured output reports that are easily digestible. As will be appreciated, the structured output reports may be more easily digestible because the structured output reports may include only relevant data, which may facilitate their use in a review and/or decision-making process.

In embodiments, the structured output reports may include at least one of a human-readable structured report that may be structured for easy consumption by an operator, and a machine-readable structured report configured to facilitate machine operations. In aspects, an easily digestible structured report may refer to a human-readable output report configured such that an operator may look at the report and may make a decision based on the report without significant effort relative to a decision made based on the unstructured data. Additionally, an easily digestible structured report may refer to a machine-readable output report configured for input into an automated machine process, such as a machine-based decision process, such that the machine process may decode the structured output record and may use the information for decision-making. As will be appreciated, functionality to provide human-readable output reports and machine-readable output reports provides flexibility to users, e.g., users that may not have not the capability to consume machine-readable reports may consume human-readable reports. Additionally, the machine-readable structured report may include a structure for encoding data for machine consumption. For example, a machine-readable structure may refer to a data structure defined using an Extensible Markup Language (XML) file. In these cases, the XML structure may define the encoding of the data. For example, a target structure may include a target XML structure which defines the format and rules into which data may be encoded.

In embodiments, the various functions of system 100 may be performed automatically, or may include at least in part, manual intervention from an operator (e.g., operator input to specify parameters for document input, to define the structural rules, to select relevant data to include in the structured reports, etc.).

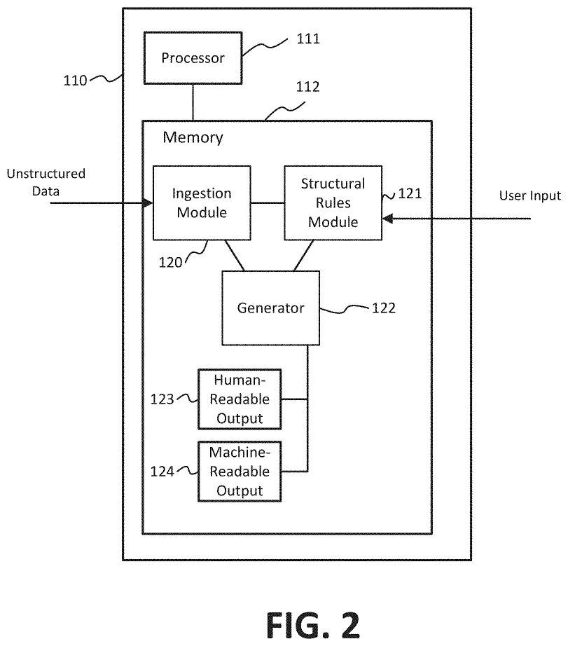

Although the various components of system 100 are illustrated as single and separate components in FIGS. 1 and 2, it will be appreciated that each of the various illustrated components may be implemented as a single component (e.g., a single application, server module, etc.), may be functional components of a single component, or the functionality of these various components may be distributed over multiple devices/components. In such aspects, the functionality of each respective component may be aggregated from the functionality of multiple modules residing in a single, or in multiple devices.

Also, it is noted that the functional blocks, and components thereof, of system 100 of embodiments of the present invention may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally or alternatively, when implemented in software, one or more of the functional blocks, or some portion thereof, may comprise code segments operable upon a processor to provide logic for preforming the functions described herein.

In embodiments, data sources 170 may comprise at least one source of unstructured data. Unstructured data may refer to information expressed in natural language, may include information structured differently than the desired structured output, and may include information structured differently in different files of data sources 170. Data sources 170 may include files having various formats (e.g., pdf, txt, doc, etc.). In one particular example, data sources 170 may include data related to insurability of a person, such as medical records, and may include sources such as a medical provider's office, clearing houses, hospitals, laboratories, scanning services providers (e.g., organizations that obtain physical copies of records and scan the records), insurance providers, etc. In some aspects, data sources 170 may include or may be part of an electronic health system from which electronic medical records may be provided. In some aspects, information related to the insurability of a person may be spread over a particular document, or documents, in the data from data sources 170. For example, information related to a doctor's office visit of a particular person (e.g., chief complaint, medications, diagnosis, etc.) may be included in different sections of a single document, or may be spread over several documents. Similarly, a transcript of a telephone conversation may be included in data sources 170. The telephone conversation transcript may include insurability information, such as (e.g., chief complaint, medications, diagnosis, etc.) which may be useful in making insurability decisions. However, it will be appreciated that identifying and tagging such information from data sources 170 manually may be difficult, tedious, and error-prone. As will be further appreciated, aspects of the present disclosure provide a mechanism to alleviate the deficiencies of these existing systems.

Collection database 160 may be configured to store data compiled from data sources 170. In some aspects, the data from data sources 170 may be provided to collection database 160 for storage, and for use during operations. The compiled data may include the data from data sources 170, or may include a subset of the data from data sources 170. For example, an operator may specify, via end user device 180, parameters and/or rules for determining what type of data, and/or what data from data sources 170 may be compiled into collection database 160. In some embodiments, compiling data from data sources 170 into collection database 160 may comprise pre-processing the data. For example, data from data sources 170 may include scanned files, image files, and or other type of non-searchable files. In this case, the unstructured input files may be OCR'd (optical character recognition). In some cases, the data from data sources may include different types of files, and these files may be converted into a single file format (e.g., pdf) when being compiled.

End user device 180 may be configured to provide a Graphical User Interface (GUI) to facilitate user input and output operations in accordance with aspects of the present disclosure. End user device 180 may be configured to accept input from users that may be used to specify various parameters, values, selections, structural rules, etc. to be used during operations, to provide various views to the user for such operations, and/or to display the structured output reports. Input output operations may also include operations for selecting and/or specifying structural rules to populate fields of the structured output reports, and to identify relevant data based on the structural rules to be included in structured output reports, for validating and/or selecting the identified relevant data to include in the structured output reports. These functions are described in more detail below. End user device 180 may be implemented as a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof.

As mentioned above, the various components of system 100 may be communicatively coupled to one another via network 190. Network 190 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc., that may be configured to facilitate communications between server 110, collection database 160, end user device 180, and data sources 170.

Server 110 may be configured to receive unstructured data from data sources 170, to provide classification and tagging of the data, to identify relevant data for populating fields of structured output reports, and to generate the structured output reports. This functionality of server 110 may be provided by the cooperative operation of various components of server 110, as shown in FIG. 2, and as will be described in more detail below. Although FIG. 2 shows a single server 110, it will be appreciated that server 110 and its individual functional blocks may be implemented as a single device or may be distributed over multiple devices having their own processing resources, whose aggregate functionality may be configured to perform operations in accordance with the present disclosure. Furthermore, those of skill in the art would recognize that although FIG. 2 illustrates components of server 110 as single blocks, the implementation of the components and of server 110 is not limited to a single component and, as described above, may be distributed over several devices or components.

As shown in FIG. 2, server 110 includes processor 111, memory 112, ingestion module 120, structural rules module 130, and generator 122. Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some aspects, as noted above, implementations of processor 111 may comprise code segments (e.g., software, firmware, and/or hardware logic) executable in hardware, such as a processor, to perform the tasks and functions described herein. In yet other aspects, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein. Memory 112 may also be configured to facilitate storage operations. For example, memory 112 may comprise a database (not shown) for storing user profile and reference information, predefined templates, predefined structural rules, etc., which system 100 may use to provide the features discussed herein.

Ingestion module 120 may be configured to receive unstructured data as input. For example, unstructured data from data sources 170, and/or from collection database 160, may be provided to ingestion module 120. In some embodiments, ingestion module 120 may be configured to sort and filter the unstructured data based on user-defined parameters. The user-defined parameters may specify the type of data, documents, and/or sources that may be ingested by ingestion module 120. For example, a user may specify filtering data to be ingested to include data related to particular topic, entity, time period, etc. In this sense, ingestion module 120 operates to provide quality control of the data to be ingested into server 110. For example, in a particular example, a user may desire to validate a disability insurance claim. In this case, the user may specify parameters for ingestion module 120 to ingest data related to the disability, medical reports, etc. In some aspects, the filtering of the ingested data may be automated, using machine learning and/or statistical algorithms, and may be based on the user-defined parameters. In these cases, the machine algorithms may identify the appropriate data and filter it based on the user-defined preferences/parameters.

Structural rules module 121 may be configured to facilitate configuration of structural rules for populating fields of the structured output reports. In some embodiments, the structural rules may define various fields associated with citations to be included in the structured output reports. As used herein, a citation may refer to an item of information that may include various fields of data. For example, a citation may refer to an item of information such as a hospital visit, a doctor's office visit, medical procedures, labs, conversations, medical history, family history, etc. As can be appreciated, the information related to a particular information, e.g., the information to be included in the fields associated with the citation, may be included in a single document, spread over several documents, or in a portion of a document of the unstructured data sources. In this sense, the structural rules may define the various information that may be included for the various fields, and may specify what information may be required and what may be optional. In some embodiments, one structural rule may apply to various fields of a structured output report, and may define what information is to be included in the various fields.

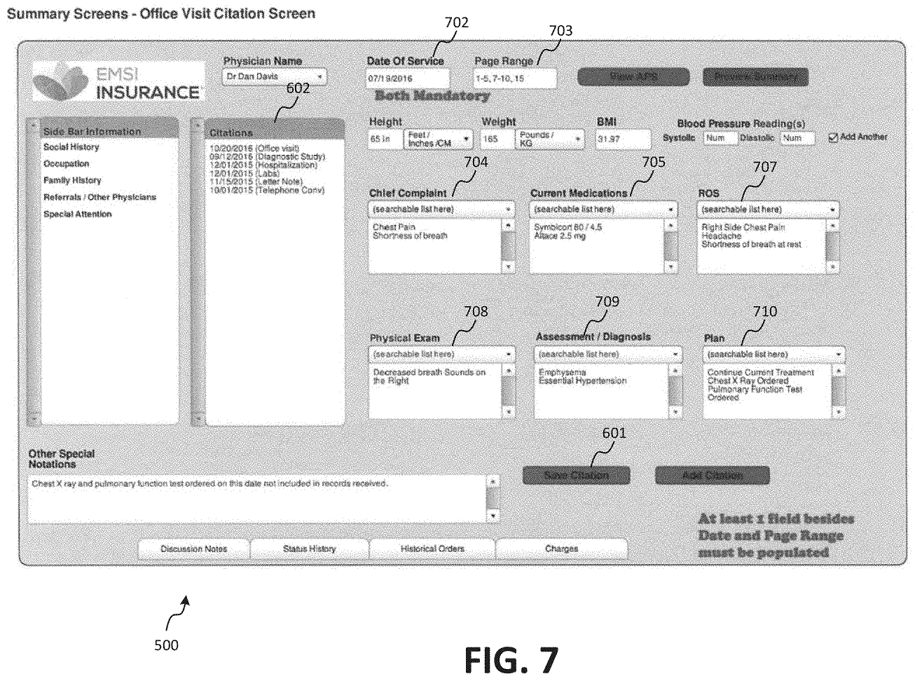

FIG. 7 illustrates an example in which several citations (e.g., citations 602) have been determined to be included in structured output reports. In this case, for a particular citation, e.g., “Office Visit,” a structural rule may be provided that defines fields related to the “Office Visit” citation that may be populated with information for inclusion in the structured output report. For example, such a structural rule may define that a field 702, “Date of Service,” may be required to be included for the “Office Visit” citation in the structured output report. In addition, various other fields may also be defined that may be included. For example, fields 703-710 may also be defined by the structural rule. These fields may then be populated, as described with respect to operations of generator 122, with relevant information, and the information may be included in the structured output report. As will be appreciated, the information included in the structured output report may be structured in accordance with the structural rules, or may be structured based on predetermined template. For example, in some embodiments, the height information defined in the “Office Visit” citation may be included in the structured output report as associated with the particular office visit, or may be included in the structured output report as a standalone field.

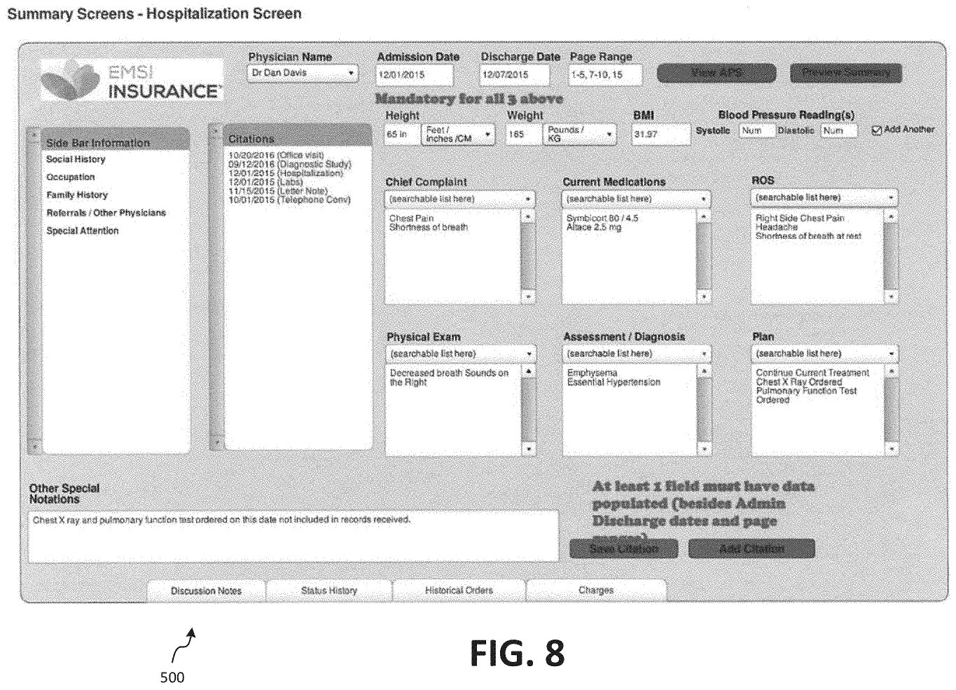

It is noted that, in some embodiments, the information for a particular field obtained with respect to a particular structural rule may be compiled without necessarily associating it only to the particular structural rules. In this case, the information may be compiled with information obtained from other structural rules, e.g., for other citations, and may be used to generate trend information. For example, the height and date obtained with respect to the “Office Visit” citation from the example illustrated in FIG. 7 may be compiled and combined with a height and date obtained based on a structural rule for a “Hospital Visit” citation, as illustrated in FIG. 8. The height and date values obtained from the two different structural rules may be combined to form a graph, for example, showing the progression of the patient's height at different times. The graph may be included in the structured output reports (e.g., the human-readable output report). It will be appreciated, that this compiling and combining may be done with any information from any citation and/or structural rules. For example, graphs and/or charts showing medication dosages, cholesterol levels, etc., over time may also be formed based on information obtained from different structural rules.

In some embodiments, the structural rules may be predefined, and/or may be dynamically defined by a user. For example, predefined structural rules may be created and stored in a database (e.g., database of memory 112) and/or a user may use end user device 180 to dynamically create and configure predefined structural rules to be used by system 100. In some embodiments, a template may also be defined that may include various fields and sections to be included in the structured output reports. In that sense, while a template may define the structured output reports, the structural rules may define the information to be included in the various fields and sections of the structured output reports. It is noted that different templates and different structural rules may be defined for different use cases and for different structured output reports.

With reference back to FIG. 2, the data ingested by ingestion module 120, which may include unstructured data, and the structural rules from structural rules module 121 may be fed into generator 122. Generator 122 may be configured to apply the structural rules to the unstructured data to populate the appropriate fields of the structured data reports with the relevant information. In some embodiments, generator 122 may be configured to process the unstructured data and to classify and tag the data. For example, generator 122 may apply classification algorithms, such as natural language processing (NLP) algorithms, and/or other classification algorithms, to the unstructured data to classify and/or tag the various data. In aspects, classification algorithms may include any combination of machine learning algorithms (e.g., regression algorithms, classification trees, vector analysis, etc.), statistical algorithms, and/or any algorithm configured to identify correlations and/or relationships within and between data, and to train a model such that the model may be used to classify data according to the training. In this manner, the unstructured data may be classified into dates, entities, times, medications, symptoms, procedures, diagnoses, locations, dosages, type of visits, etc. In embodiments, the classification and tagging of the data may be performed manually. In some embodiments, data sources 170 may include structured data. For example, in some cases, data sources 170 may include continuity of care document (CCD) data, which may be structured data. In these cases, the particular structure, which may be previously known, maybe used to identify and tag relevant information.

The application of the structural rules by generator 122 may be done manually, e g., by a user selecting a structural rule, and then selecting the information that is to be included in the various fields defined by the structural rules. For example, with reference to FIG. 7, a user may manually select what information to use to populate field 704, “Chief Complaint.” The user may select “Chest Pain” or “Shortness of Breath,” and once selected, the appropriate information is used to populate field 704. Correspondingly, the selected information is included in the structured output reports. In some embodiments, the application of the structural rules by generator 122 may be automatic. In this case, generator 122 may automatically apply the structural rules, identifying the relevant information to be included in the various fields defined by the structural rules, based on the classification of the unstructured data. As noted above, the functionality of generator 122 may be implemented in a single component, functional components of a single component, or may be distributed over multiple devices/components. In such aspects, the functionality of each respective component may be aggregated from the functionality of multiple modules residing in a single, or in multiple devices.

Once relevant information has been used to populate the various fields defined by the structural rules, the relevant information is used to generate the structured output reports. In embodiments, the structured output reports may include at least one of human-readable structured report 123 and machine-readable structured report 124, as described above. It is noted that machine-readable structured report 124 may include different data types and outputs that may be helpful for later processing (e.g., for automated algorithms to implement scoring or to make determinations). For example, machine-readable structured report 124 may include data structured as various medical codes, such as information related to a diagnosis, in a format supporting an International Classification of Diseases 10 (ICD-10) code. In this sense, machine-readable structured report 124 structures the information related to an impairment or disease in a way that machine may be able to read the ICD-10 code.

In some embodiments, generator 122 may also be configured to provide decision-making functionality. The decision-making functionality may be part of an automated decision flow. For example, in some implementations, the structured output reports, (e.g., the machine-readable structured report) may be further processed within the context of decision-making. In such a case, for example, a decision-making process may determine, based on the structured output reports, whether or not a particular patient may be insurable, whether or not a clinical result is valid, whether or not medical records support a particular legal conclusion, etc., depending on the use case and application context. In some embodiments, special codes may be created for different types of data, such as for types of specialist, frequency of visits, etc., and ratings may be provided with respect to the data. The ratings and/or codes may be included in the structured output reports. In some embodiments, the automated decision-making process may even make diagnoses, and provide the appropriate codes. For example, the automated decision-making process may use the structured information to determine a diagnosis, and to then code the diagnosis. As will be appreciated, the automated decision-making process may make the diagnosis based not only one particular visit or look at a patient, but with the benefit of data spanning longer periods of time, which provides an advantageous approach. In addition, in some embodiments, the decision-making functionality of generator 122 may also correct miscoded diagnoses. For example, a particular diagnosis may have been coded with a particular code during a doctor's visit. However, generator 122 may identify, based on the overall collected data, that the code may be been incorrect, or incomplete, and may make the appropriate corrections. Accordingly, a report generated by generator 122, which contains a more holistic view of a patient's medical history, may change or alter physician-specified data (e.g., diagnoses) in its generated product. Such data points will assist an end user that is using the reports to make various determinations (and will inform automated determinations).

It is noted that, in some aspects, the decision-making functionality of generator 212 may be provided by a module external to generator 122, or external to server 110. For example, the decision-making functionality may be exported to external machine learning processes, such as artificial intelligence, etc., existing, or which may exist in the future, in which the structured output reports may be used in the decision-making.

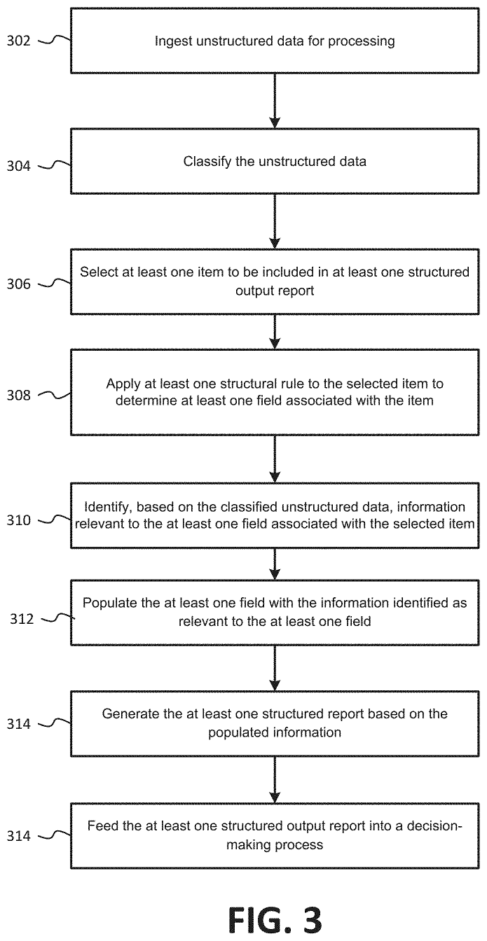

FIG. 3 shows a high level flow diagram of operation of a system configured in accordance with aspects of the present disclosure for ingesting unstructured data and generating, based on structural rules, structured output reports that are easily digestible in accordance with embodiments of the present application. The functions illustrated in the example blocks shown in FIG. 3 may be performed by system 100 of FIGS. 1 and 2, or any other suitable system, according to embodiments herein. Additionally, while the diagram in FIG. 3 is set forth in particular steps, nothing in this disclosure should be construed as limiting the order, or number, in which the illustrated steps are implemented. In fact, some steps may be implemented in different order, simultaneously, at multiple points in time, or not at all. In addition, portions of this functional flow diagram may be performed within any of the blocks illustrated in FIG. 3, or may be performed within its own functional block.

In general terms, embodiments of the present disclosure provide functionality for ingesting voluminous amounts of data, efficiently generating structured output reports from the voluminous amount of data, and facilitating decision-making based on the structured output reports, all with a level of automation. Aspects of the present disclosure allow for identifying relevant data to be included in the structured output reports based on structural rules that define fields that may be used to identify the relevant data. The structural rules may be associated with particular fields, sections, and/or topics to be included in the structured output reports. The structured output reports may then be used by a user and/or as part of an automated decision-making process. As such, the review process by an end-user is significantly improved. Therefore, Applicant notes that the solution described herein is superior, and thus, provides an advantage over prior art systems.

One application of the techniques and systems disclosed herein may be for insurance providers. As noted above, insurance providers may be required to review and analyze large amounts of data and documents, which are usually unstructured, in order to determine the insurability of a particular applicant. Typically, the data is analyzed and reviewed manually by a user, and a summary of the data is then generated. The summary may be large as well, even hundreds of pages. Aspects of the present disclosure provide an advantageous system that allows not only for easy identification of relevant information within the unstructured data, but to also automatically generate a summary report that is concise and relevant. A user reviewing the summary report may easily identify information and make a decision with respect to insurability of the applicant. In addition, the output report is a structured report, which allows for its ingestion into a decision-making process, which may be automated. It is noted that the discussion that follows, which is directed to insurability, is merely an example embodiment and should not be construed as limiting in any way.

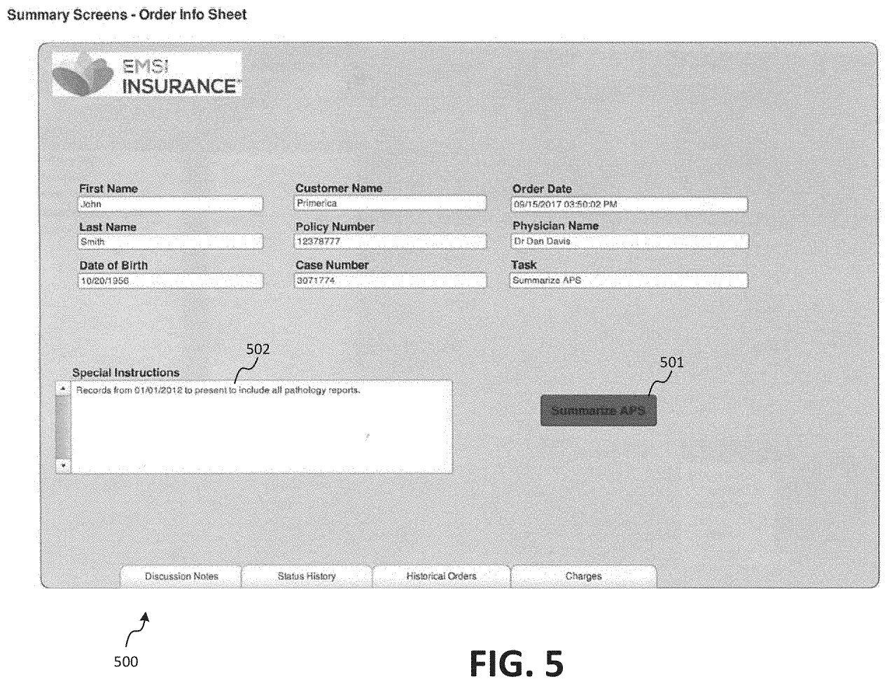

At block 302, unstructured data is ingested for processing. In embodiments, the unstructured data may have already been collected and compiled into a database from various sources, as described above. The compiling of the unstructured data may include preprocessing the data to ensure that it is in a particular format (e.g., pdf). In some embodiments, the ingesting operations at block 302 may be triggered by a user placing an order for a structured output report. For example, FIG. 5 shows a view of GUI 500, showing an order page. A user may place an order for a summary by specifying various information. In particular, the user may specify parameters for the order. For example, in element 502, a user may specify that the ordered structured output report may include information limited to records from a specific time period, and to include particular types of reports. In this manner, a user may specify parameters for the documents that may be ingested for processing. Thus, the unstructured data may be filtered based on these user-defined preferences in order to ensure than only data related to a particular case, as specified by the user, is ingested. A user may trigger the ingesting operations at block 302 by activating element 501.

Referring back to FIG. 3, at block 304, the unstructured data ingested at block 302 is classified. In aspects, as discussed above, the classification of the unstructured data may be performed manually, by a user reviewing the ingested data and identifying, and optionally tagging, particular items of interest. For example, a user may review the unstructured data and, upon identifying a chief complaint associated with a hospital visit, the user may classify the portion of unstructured data referring to such chief complaint as a chief complaint, and may tag the chief complaint as associated with the hospital visit. In some embodiments, the classification and tagging of the unstructured data may be performed automatically, using, for example, NLP classification models and algorithms, as described above.

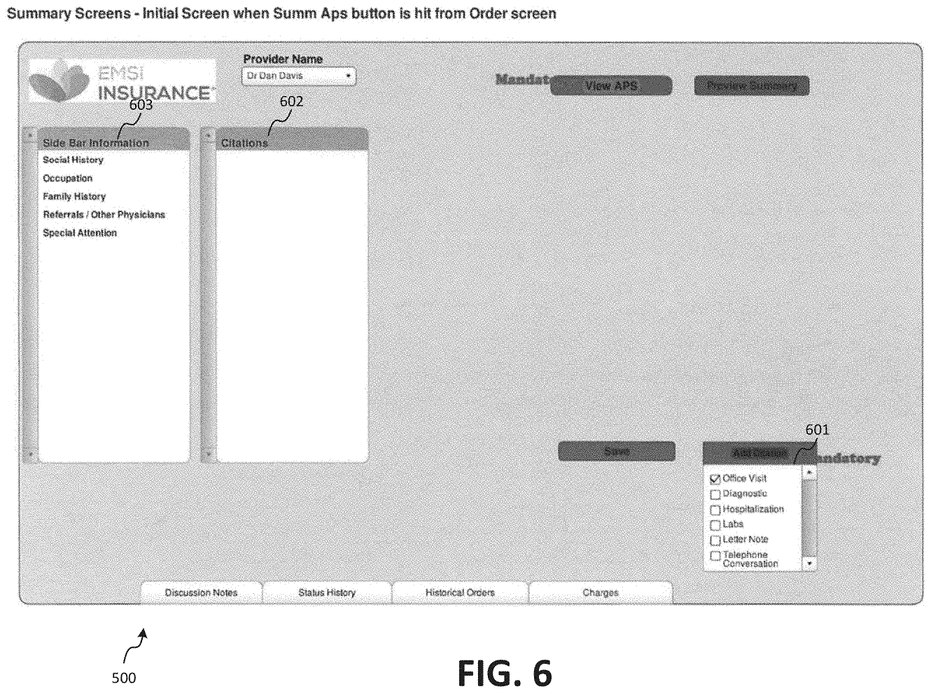

At block 306, at least one item is selected to be included in a structured output report. For example, with reference to FIG. 6, a user may select an item (e.g., citations and/or side bar information items) to be included in the structured output report. Citations list 602 may show the citation items to be included in the structured output report, and element 603 may show the side bar information items to be included in the structured output report. Currently, there are no citations to be included in the structured output report. A user may select a citation item to be included by selecting a citation from the options in element 601. As shown, a citation item may be one of an office visit, a diagnostic, a hospitalization, labs, letter note, and/or a telephone conversation. It is noted that this list is not intended to be exhaustive, and various other types of citations may be included as items. Thus, the list in element 601 should not be construed as limiting in any way. In the example illustrated in FIG. 6, a user may select a citation item of type “Office Visit.” Doing so may cause an item of type “Office Visit” citation to be included in the structured output report. It should be appreciated that, at this point, the item of type “Office Visit” citation does not yet include any particular information. Rather, the item of type “Office Visit” citation at this time may be thought of as a placeholder, or a template, for information that, once populated, may be included in the structured output report.

In some embodiments, the items to be included in the structured output reports may be defined by a predefined template. For example, element 603 includes side bar information items that are to be included in the structured output report. These items may not have been selected to be included by the user, but rather, the inclusion of these items in the structured output report may be determined by a predetermined template of what the structured output report is desired to include.

Once an item is selected to be included in the structured output report, at least one structural rule is applied, at block 308, to the selected item to determine the fields of information associated with the item. In aspects, the structural rule may define the fields that are associated with the selected item. As such, the structural rules may be thought of as defining the information that is to be included in the structured output report for the selected item. In some implementations, a structural rules may define the fields that are associated with every item of the same type (e.g., a single structural rule defines fields for all citations of type “Office Visit”). In other implementations, a structural rule is used for every item. (e.g., a structural rule is provided for every citation of type “Office Visit”). FIG. 7 shows another view of GUI 500, in which a structural rule has been applied to an item of type “Office Visit.” In this example, as can be seen, the structural rule defines various fields for information related to the appropriate office visit. The structural rule may define a field for including a date of service for the office visit, and a page range field for including the pages in which the office visit citation may be found within the corresponding document. The structural rule for the item of type “Office Visit” may also include a field for height and weight, for body mass index (BMI), and for blood pressure readings. In some embodiments, the BMI may be calculated automatically from the height and weight values. The structural rule for the item of type “Office Visit” may also include fields for including information on the chief complaint, current medications, review of systems, physical exam, assessments/diagnosis, and a treatment plan. In embodiments, some of the defined fields may be required. For example, data of service field 702 and page range field 703 may be both required. In this case, during population of the fields, a value must be included in each of these fields. It is noted that, at this time, the various fields of the selected item of type “Office Visit” citation may not have yet been populated with information. For example, chief complaint field 704 may be defined as a field for the office visit citation, but the field may not have been yet populated with the relevant information. Operations to populate the various fields specified by the structural rules will be discussed below with respect to block 310.

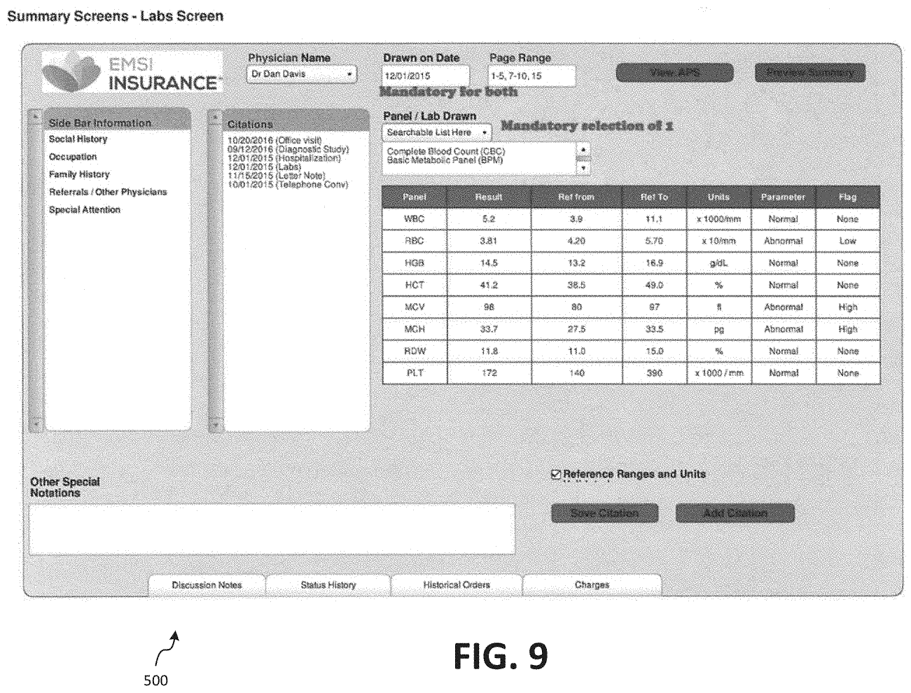

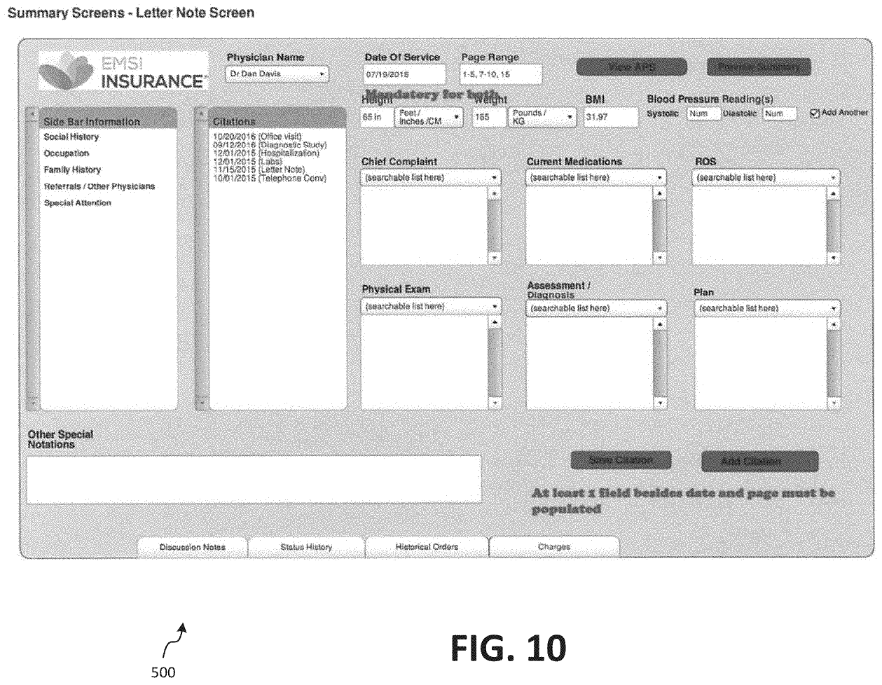

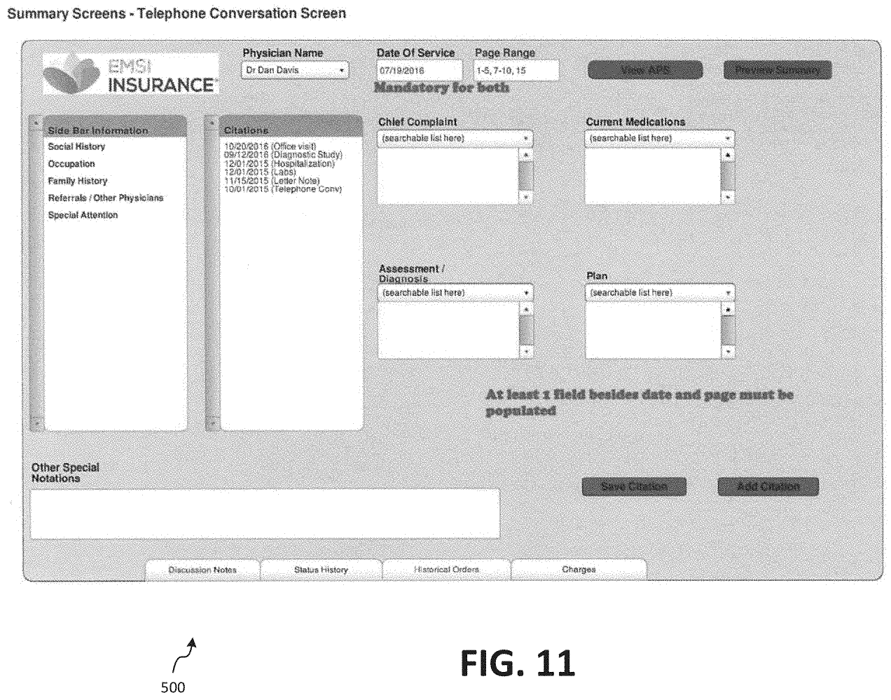

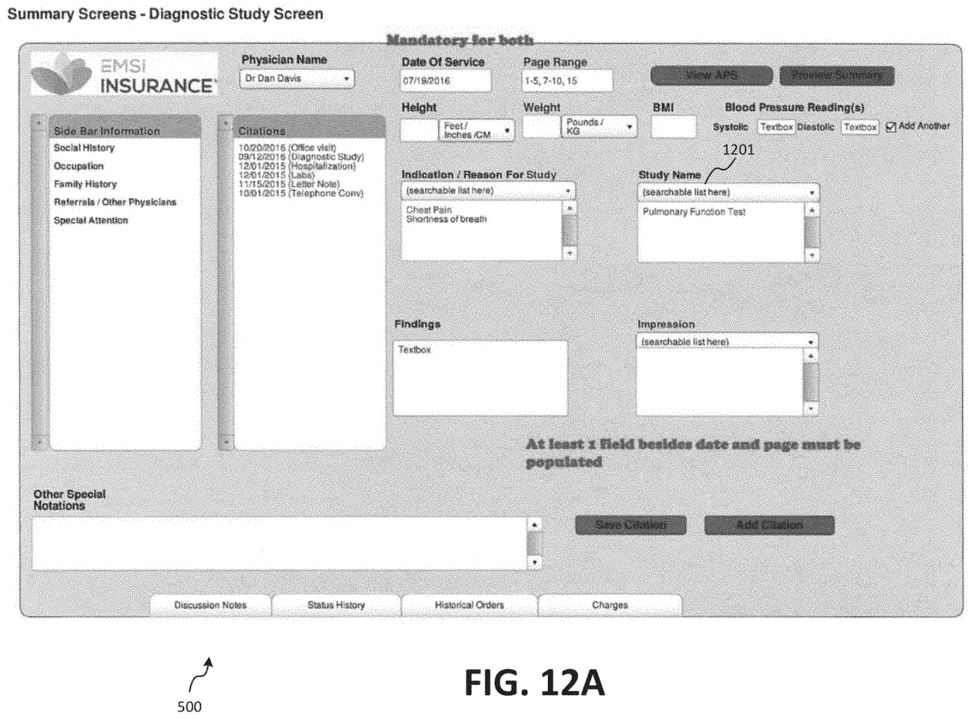

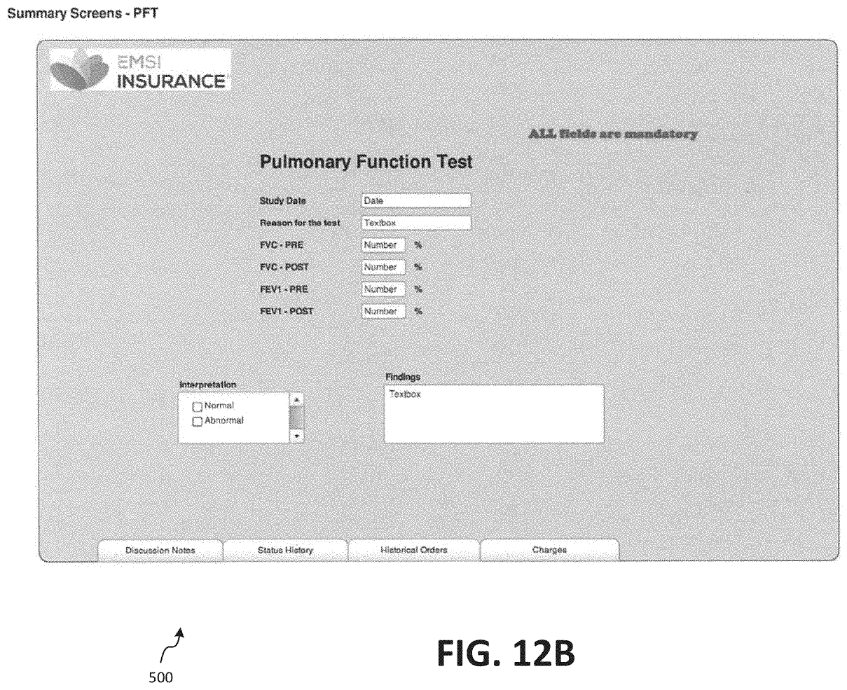

FIGS. 8-11 show other views of GUI 500, in each of which a structural rule is applied to items of different types, including hospitalization, labs, letter note, and telephone conversation. In each of these cases, a structural rule defines various fields for information related to each of the corresponding item types. FIG. 12A shows a view of GUI 500, in which a structural rule is applied to an item of type “diagnostics.” As with above, the structural rule defines various fields for information related to the diagnostics type item. In particular, field 1201 may be provided for including information related to the study name. For example, the study may be a pulmonary function test. In this case, when selecting the information to be included in field 1201, in accordance with operations of block 310 discussed below, another view of GUI 500 may be triggered, as seen in FIG. 12B. The new view may include further fields for information to be included related to the selected study. The new view may be a pop-up, or may be an entire new tab or window, and may cause operations to be paused until information for the various fields is populated.

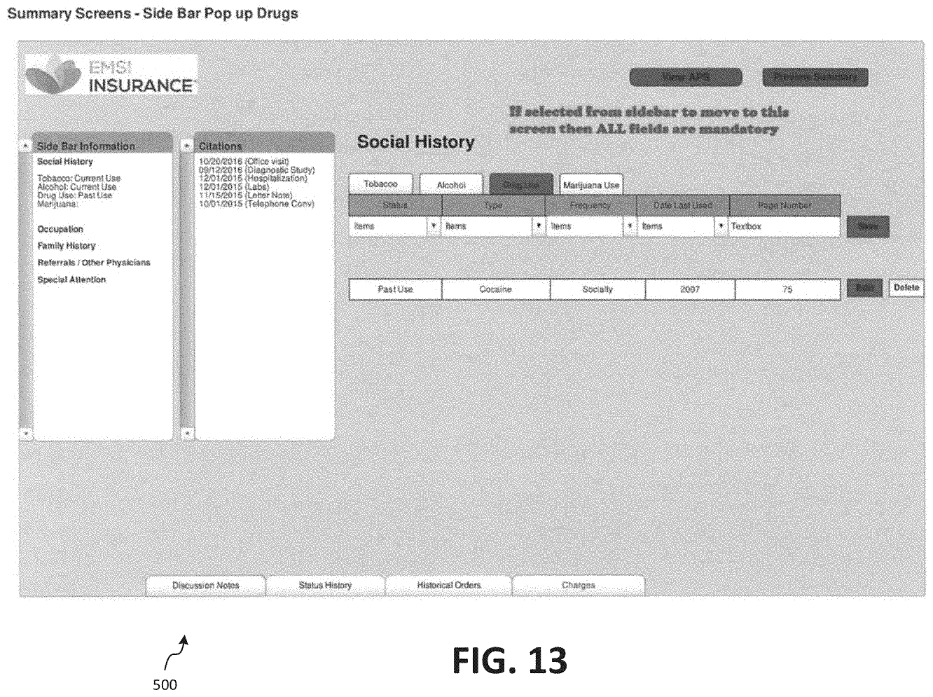

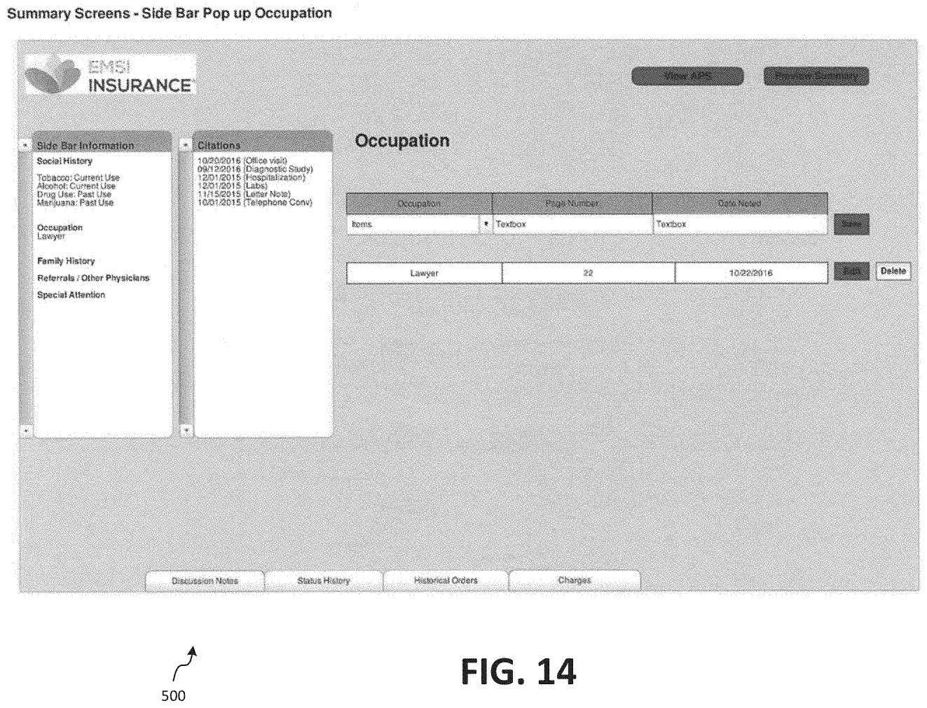

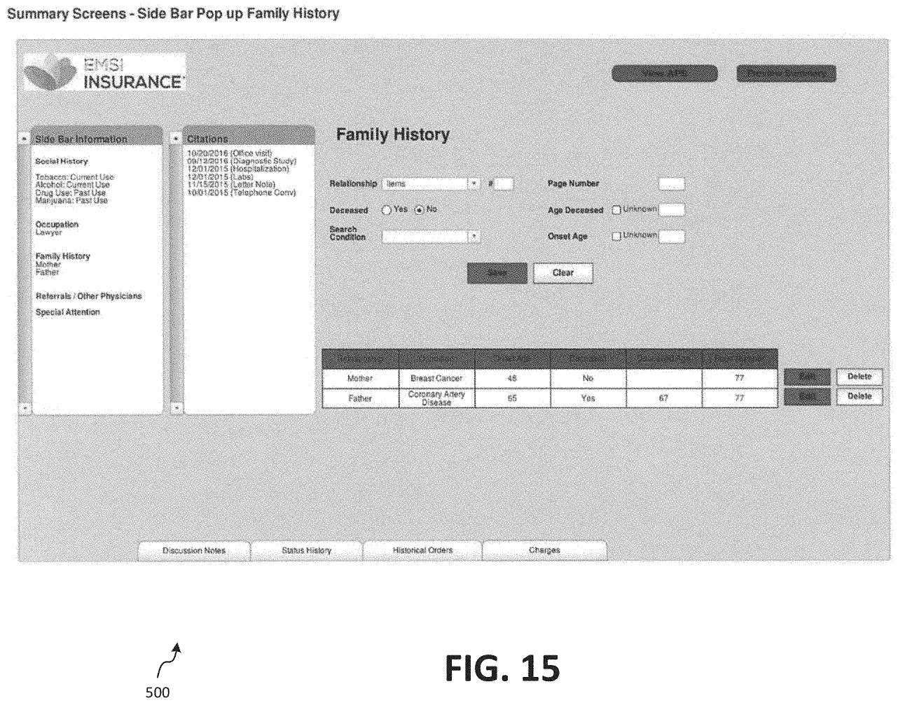

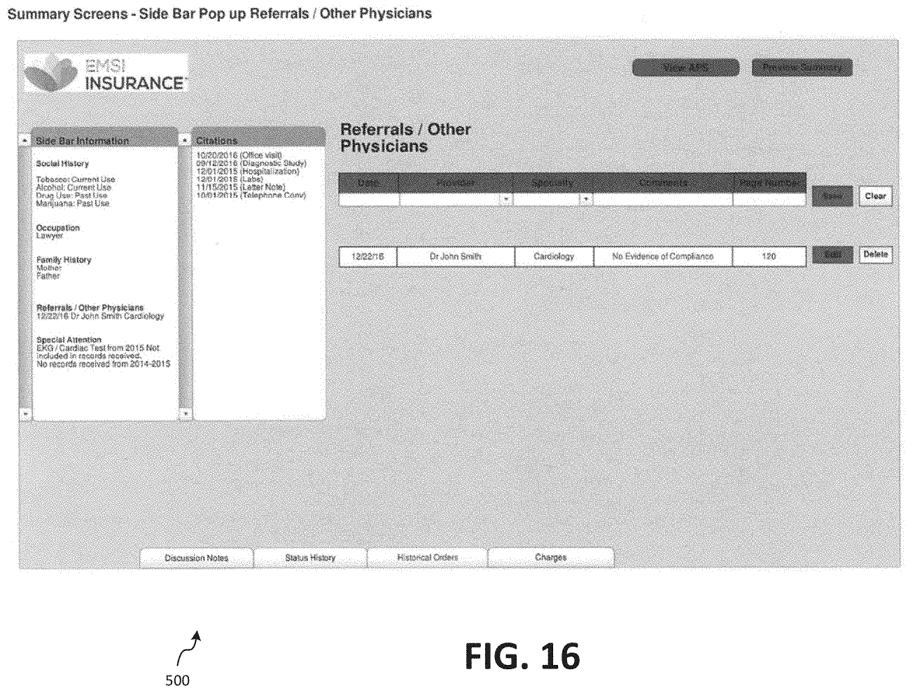

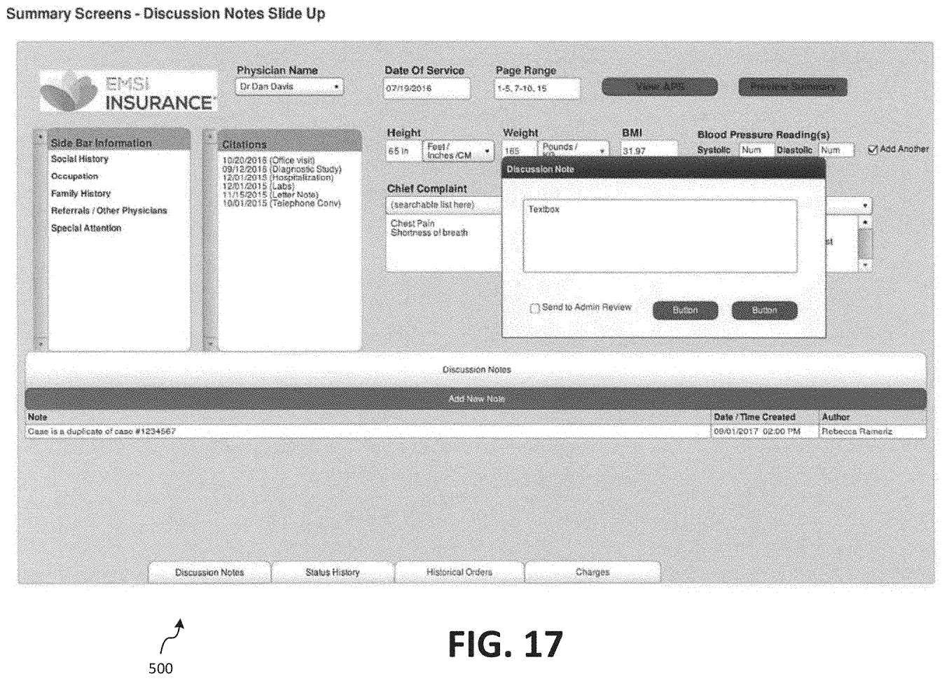

FIGS. 13-16 show other views of GUI 500, in each of which a structural rule is applied to side bar information items of various types. These various types may include social history, occupation, family history, referrals, and special information. In each of these cases, a structural rule defines various fields for information related to each of the corresponding side bar information item types. In some embodiments, side bar information items may include information that may be included in multiple citations. As such, in some cases, the rules defining the various fields for the side bar information items may also apply to multiple citations. As with the citation items, at this time, the various fields of the corresponding side bar information items may not have yet been populated with relevant information. Operations to populate the various fields specified by the structural rules will be discussed below with respect to block 310.

Referring back to FIG. 3, at block 310, information relevant to the fields of information associated with the selected item (e.g., a selected citation) is identified based on the classified unstructured data. In some embodiments, the information relevant to the various fields of the selected item, as defined by the associated structural rule, may be identified based on the classification and tagging at block 304. As noted above, the unstructured data may be classified and tagged, which may facilitate identification of information that is relevant to each, or at least one, of the fields defined by the structural rule. For example, with reference again to FIG. 7, the structural rule for a citation item of type “Office “Visit” may define a field 704 for including information on a chief complaint. In this case, two data items have been identified as potentially relevant to field 704: “chest pain” and “shortness of breath.” In this case, a user may manually select the data item that is deemed relevant to field 704. In some embodiments, the selection of a relevant data item may be performed automatically, using machine algorithms as described above. At block 312, the fields of the selected item are populated with the information identified as relevant.

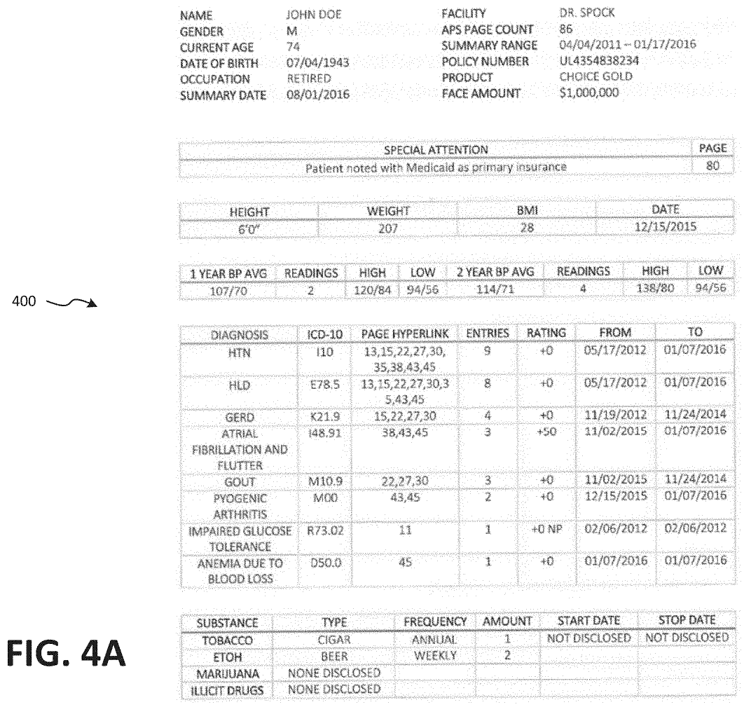

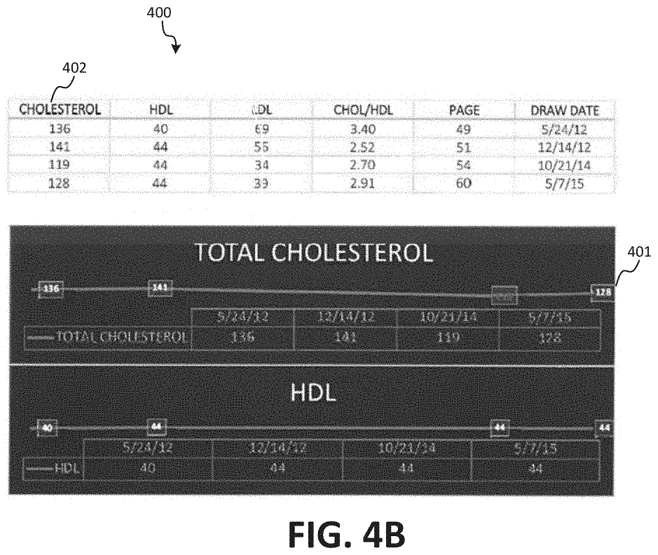

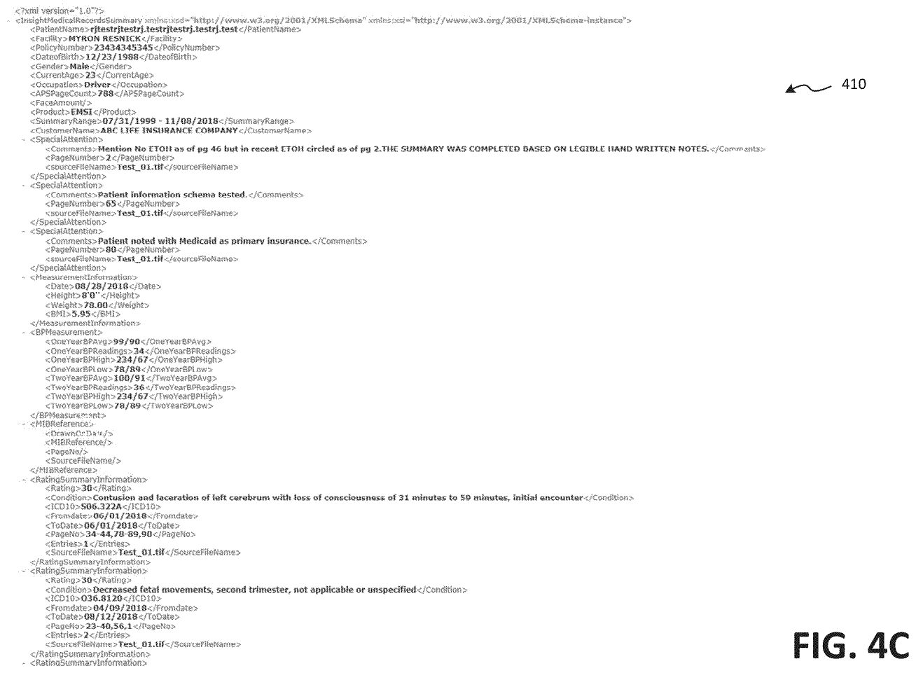

Referring back to FIG. 3, at block 312, the structured output reports are generated based on the populated information. In embodiments, the structured output reports may include at least one of a human-readable structured report that may be structured for easy consumption by an operator. FIGS. 4A and 4B illustrate an example showing portions of human-readable structured report 400. As can be seen, human-readable structured report 400 includes various structured fields with relevant information. As noted above, the information in the various fields of human-readable structured report 400 may correspond to the information populated in the various fields defined by the various structural rules of the various items (e.g., citations) selected for inclusion. In some embodiments, the information identified as relevant, and/or even information not necessarily identified as relevant, but at least ingested at block 302, may be compiled and combined to generate charts and graphs. For example, as shown in FIG. 4B, chart 402 may be constructed using information identified during operations. In addition, graph 401 may also be formed, showing the progression of cholesterol levels over a period of time. As will be appreciated, chart 402 and graph 401 provide a powerful visual cue for a user reviewing structured report 400, showing a consistent level. This may facilitate a decision by the reviewer. It will be appreciated that similar charts and graphs, and/or other devices for presenting and summarizing data may also be used for any type of data.

In some embodiments, the structured output reports may also include a machine-readable structured report configured to facilitate machine operations. In aspects, the machine-readable output report may be configured for input into an automated machine process, such as a machine-based decision process, such that the machine process may decode the structured output record and may use the information for decision-making. FIG. 4C illustrates an example showing a portion of machine-readable structured report 410. As can be seen, machine-readable structured report 410 includes various structured fields with relevant information. As noted above, the information in the various fields of machine-readable structured report 410 may correspond to the information populated in the various fields defined by the various structural rules of the various items (e.g., citations) selected for inclusion. In aspects, the machine-readable structured report may include an XML report.

Referring back to FIG. 3, at optional block 314, the structured output reports are fed into a decision-making process. In some embodiments, the decision making process may be part of an automated decision flow, and may include processing the structured output reports using machine learning algorithms to make decisions. In such a case, a decision-making process may determine, based on the structured output reports, whether or not a particular condition exists. The condition may be dependent on the use case. In some embodiments, the decision making process may include a manual decision-making process. For example, a user may consume the human-readable structured report and may make decisions based on the information provided therein. As discussed above, the human-readable structured report may represent a clear and concise summary report from which the user may easily identify relevant information. For example, a user may make a decision with respect to insurability of an applicant easily and efficiently using the human-readable structured report.

One application of the techniques and systems disclosed herein may be in medical insurance analysis. It is noted that, although the discussion that follows is directed to medical insurability, this is merely an example embodiment and should not be construed as limiting in any way.

As noted above, insurance providers may be required to review and analyze large amounts of data and documents, which are usually unstructured, in order to determine the insurability of a particular applicant. Typically, the data is analyzed and reviewed manually by a user, and a summary of the data is then generated. The summary may be large as well, even hundreds of pages. Aspects of the present disclosure provide an advantageous system that allows not only for easy identification of relevant information within the unstructured data, but to also automatically generate a summary report that is concise and relevant.

In some embodiments, during operation, unstructured data may be ingested by a system implemented in accordance with aspects of the present disclosure. The unstructured data may include documents related to medical records. The unstructured data may be ingested and processed, and may be classified, as described above. In embodiments, the classification of the unstructured data may be performed manually or may be performed automatically using machine learning algorithms.

A user may perform selection of citations to be included in the structured output report to be generated. For example, a user may select one or more citations as shown in FIG. 6. The citations selected may include a citation and/or side bar information. Structural rules may be defined for the selected citations to be included in the structured output report. In embodiments, the structural rules may define the various fields of information to be included for the selected citation. For example, as shown in FIG. 7, various fields of information are to be included for an office visit citation in the structured output report. These various fields may be defined by a structural rules. In some cases, the structural rules may also apply to all office visit citations, or different structural rules may be defined for different office visit citations. Some fields may be required while other fields may be optional.

A user may select information, from the classified unstructured information, to populate the various fields defined for the selected citation. In some embodiments, the information to be populated in the various fields may be selected manually by the user, or machine learning algorithms may be apply to select the information and populate the various fields for the selected citation.

The user may select additional citations to be included in the structured output report to be generated. In this case, structural rules may define the fields associated with the additional citations, and information may be identified and selected to populate the fields of the additional citations.

Once all citations desired to be included in the structured output report have been selected and the various fields associated with the citations have been populated with relevant information, the relevant information may be used to generate the structured output report. The structured output report may include the information, structured based on the structural rules for the various citations, or based on a predefined template. In aspects, the structured output report may represent a summary of the unstructured data that includes information deemed relevant to the medical insurance review. For example, a human-readable structured report, e.g., structured report 400 shown in FIGS. 4A and 4B may be generated. In some embodiments, a machine-readable structured report may also be generated. A user reviewing the structured output report may easily identify information and make a decision with respect to insurability of the applicant. In addition, the structured output report allows for its ingestion into a decision-making process, which may be automated.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1 and 2 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method of automatically generating at least one structured report based on at least one structural rule, comprising:
receiving unstructured data from at least one source;
classifying at least a portion of the unstructured data into an appropriate category;
selecting a citation to be included in the at least one structured report;
applying the at least one structural rule to the selected citation to determine a plurality of fields associated with the selected citation, wherein the at least one structural rule defines the plurality of fields associated with the selected citation;
identifying, based on the classified at least a portion of the unstructured data, information relevant to the plurality of field associated with the selected citation;
populating the plurality of fields associated with the selected citation with the information identified as relevant; and
generating the at least one structured report based at least in part on the populated information.

2. The method of claim 1, further comprising feeding the at least one structured output report into a decision-making process.

3. The method of claim 2, wherein the decision-making process includes an automated process applying at least one machine-learning algorithm.

4. The method of claim 1, wherein the classifying the at least a portion of the unstructured data into the appropriate category includes applying at least one classification algorithm to the at least a portion of the unstructured data, and wherein the classification algorithm includes machine learning algorithms and/or statistical algorithms.

5. The method of claim 1, wherein the classifying the at least a portion of the unstructured data into the appropriate category includes a manual classification process.

6. The method of claim 1, wherein the at least one structured report is defined by a template, and wherein the selecting the citation to be included in the at least one structured report is based on the template.

7. The method of claim 1, wherein the unstructured data includes medical reports, and wherein the at least one source is at least one of: a medical provider, a clearing house, a hospital, a laboratory, a scanning services provider, an insurance providers, and an electronic heal record system.

8. The method of claim 1, wherein the at least one structured report includes at least one of: a human-readable structured report and a machine-readable structured report.

9. The method of claim 8, wherein the machine-readable structured report includes an Extensible Markup Language (XML) report.

10. The method of claim 1, wherein the generating the at least one structured report based at least in part on the populated information includes:
identifying a diagnosis code in the unstructured data;
determining, based on the classified at least a portion of the unstructured data, that the diagnosis code is incorrect; and
determining a correct diagnosis code based on the classified at least a portion of the unstructured data.

11. A system for automatically generating at least one structured report based on at least one structural rule, comprising:
an input/output device configured to receive unstructured data from at least one unstructured data source;
a server configured to:
receive the unstructured data from the at least one unstructured data source;
classify at least a portion of the unstructured data into an appropriate category;
select a citation to be included in the at least one structured report;
apply the at least one structural rule to the selected citation to determine a plurality of fields associated with the selected citation, wherein the at least one structural rule defines the plurality of fields associated with the selected citation;
identify, based on the classified at least a portion of the unstructured data, information relevant to the plurality of fields associated with the selected citation;
populate the plurality of fields associated with the selected citation with the information identified as relevant; and
generate the at least one structured report based at least in part on the populated information.

12. The system of claim 11, further comprising feeding the at least one structured output report into a decision-making process.

13. The method of claim 12, wherein the decision-making process includes an automated process applying at least one machine-learning algorithm.

14. The method of claim 11, wherein the classifying the at least a portion of the unstructured data into the appropriate category includes applying at least one classification algorithm to the at least a portion of the unstructured data, and wherein the classification algorithm includes machine learning algorithms and/or statistical algorithms.

15. The method of claim 11, wherein the classifying the at least a portion of the unstructured data into the appropriate category includes a manual classification process.

16. The method of claim 11, wherein the at least one structured report is defined by a template, and wherein the selecting the citation to be included in the at least one structured report is based on the template.

17. The method of claim 11, wherein the unstructured data includes medical reports, and wherein the at least one source is at least one of: a medical provider, a clearing house, a hospital, a laboratory, a scanning services provider, an insurance providers, and an electronic heal record system.

18. The method of claim 11, wherein the at least one structured report includes at least one of: a human-readable structured report and a machine-readable structured report.

19. The method of claim 18, wherein the machine-readable structured report includes an Extensible Markup Language (XML) report.

20. A computer-based tool for automatically generating at least one structured report based on at least one structural rule, the computer-based tool including non-transitory computer readable media having stored thereon computer code which, when executed by a processor, causes a computing device to perform operations comprising:
receiving unstructured data from at least one source;
classifying at least a portion of the unstructured data into an appropriate category;
selecting a citation to be included in the at least one structured report;
applying the at least one structural rule to the selected citation to determine a plurality of fields associated with the selected citation, wherein the at least one structural rule defines the plurality of fields associated with the selected citation;
identifying, based on the classified at least a portion of the unstructured data, information relevant to the plurality of fields associated with the selected citation;
populating the plurality of fields associated with the selected citation with the information identified as relevant; and
generating the at least one structured report based at least in part on the populated information.
